(19) United States
(12) Patent Application Publication
(10) Pub. No.: US 2026/0316088 A1
(43) Pub. Date: Oct. 15, 2026

(54) ELECTROMAGNETIC FIELD AIR PURIFIER

(71) Applicant: FU-CHI WU, TAIPEI CITY (TW)

(72) Inventor: FU-CHI WU, TAIPEI CITY (TW)

(21) Appl. No.: 19/175,478

(22) Filed: Apr. 10, 2025

(51) Int. Cl. B03C 3/145; B03C 3/36; B03C 3/38; B03C 3/82; F24F 8/192; F24F 8/30

(52) U.S. Cl. CPC B03C 3/145; B03C 3/365; B03C 3/38; B03C 3/82; F24F 8/192; F24F 8/30

(57) ABSTRACT

An electromagnetic field air purifier includes a positively charged electromagnetic field housing, negative ion generators and a first baffle provided in the air duct inlet of the electromagnetic field housing, a first spoiler provided inside the electromagnetic field housing, and a fan provided outside the air duct outlet of the electromagnetic field housing to suck in air to flow through the negative ion generators to make foreign particles in the air positively charged, and the positively charged foreign particles collide and rebound with the inner wall of the electromagnetic field housing at high speeds under Brownian motion, so that the positively charged foreign particles in the air are attracted by the positively charged electromagnetic field housing in each super-high-speed collision, and the positively charged foreign particles in the air are quickly adsorbed on the inner wall of the d electromagnetic field housing.

### BACKGROUND OF THE INVENTION

### 1. Field of the Invention

The present invention relates to an electromagnetic field air purifier, and in particular, and in particular to an electromagnetic field air purifier which can effectively absorb and intercept foreign particles in the air and greatly improve the air purification effect.

### 2. Description of the Related Art

Exhaust gas emitted by industry and vehicles seriously pollutes the air and has a serious impact on human health. There are various harmful substances in the air that are invisible to the eyes or float in high concentrations close to the ground, as well as various industrial pollution and harmful fumes. In the absence of wind, these harmful substances will fall due to gravity or float in high concentrations near the ground, tabletops or countertops. Therefore, the concentration of polluted air is usually highest near the ground and on the table. When we move around, the wind or the natural wind from the outside will lift up these harmful substances and spread them into the air. Therefore, humans have been constantly inhaling these harmful substances in various places and spaces, which has led to various diseases.

Therefore, humans have currently designed various air purifiers for purifying air. It is known that the electrostatic dust collector design of an air purifier is to use one or more positively (negatively) charged dust collectors to be placed inside (outside) the chassis, which can absorb negatively (positively) charged foreign particles in the air passing by to achieve the air filtration function. Negatively (positively) charged foreign particles in the air can only be adsorbed when they are very close to a positively (negatively) charged dust collecting plate or in a very slow-flowing airflow.

It is known that after the air is sucked into the air purifier, it is quickly discharged from the outlet through its straight air channel. Therefore, in many cases, when the airflow is large and fast, there is a sufficient distance between the negatively (positively) charged air foreign particles and the positively (negatively) charged dust collecting plate, and the air foreign particles are moving in a straight line, so some of the negatively (positively) charged air foreign particles will be able to smoothly escape the positively (negatively) charged attraction of the positively (negatively) charged dust collecting plate and leave with the airflow. Therefore, the quality of its filtration is not ideal. The filter devices commonly used can only filter 0.1 μ particles at most. Therefore, the various types of air purifiers currently on the market have poor filtering effects, and their filters usually need to be cleaned after being used for several months. This phenomenon does not mean that the air quality is good, but is caused by poor filtering effects.

### SUMMARY OF THE INVENTION

The present invention is a further improvement of the U.S. Pat. No. 8,268,058 previously applied for by the applicant of this case. The patent technology previously applied for has completely solved the poor filtering effect of the current known air purifiers. However, due to the high cost, the inventor of the present invention hopes to design a low-cost, easy-to-disassemble and replace, high-efficiency and low-energy design without changing the high-efficiency filtering effect of the previously applied patent, so that it can be more widely used to maintain the air quality of various spaces.

The present invention relates to an electromagnetic field air purifier, which comprises a positively charged electromagnetic field housing with at least one air duct inlet provided near one end thereof and at least one air duct outlet provided on one side of an opposite end thereof, a plurality of negative ion generators provided in the air duct inlet and inside the electromagnetic field housing, at least one first spoiler provided in the electromagnetic field housing, a barrier plate provided in the electromagnetic field housing near one side of the air duct outlet to prevent airflow from directly hitting the air duct outlet, a first baffle provided near the air duct outlet, and a fan provided at an outer end of the air duct outlet. The fan draws air into the electromagnetic field housing through the negative ion generators, causing the foreign particles in the airflow to be negatively charged. The negatively charged foreign particles are driven by the continuous airflow of the fan and enter the electromagnetic field housing in a straight line, so that the negatively charged air particles in the inhaled air will collide and rebound with the inner wall of the electromagnetic field housing countless times under Brownian motion in the semi-enclosed space inside the electromagnetic field housing, and will be attracted to the inner wall of the electromagnetic field housing by the suction force of the positively charged electromagnetic field housing. Then, the at least one first spoiler installed on the inner wall of the electromagnetic field housing blocks and disturbs the airflow to increase the stagnation time and collision frequency of foreign particles in the air, thereby improving the dust collection effect. At the same time, the first baffle installed at the air duct outlet will block the few negatively charged air foreign particles that are carried to the end by the airflow, so that they will return and collide with the inner wall of the electromagnetic field housing and be completely adsorbed. The second baffle intercepts the foreign particles in the air and causes them to collide at high speed and be adsorbed again. The extremely clean air is finally discharged through the holes in the second baffle, effectively adsorbing and intercepting foreign particles in the air and greatly improving the air purification effect.

The main object of the present invention is to design the air duct inlet and air duct outlet of the present invention to be in a straight or non-straight path with the electromagnetic field housing, so that the negatively charged foreign particles in the inhaled air will have countless ultra-high-speed collisions and rebound with the inner wall of the electromagnetic field housing under Brownian Motion in the semi-enclosed space inside the electromagnetic field housing. and will be attracted to the inner wall of the electromagnetic field housing by the suction force of the positively charged electromagnetic field housing. Furthermore, the air to be discharged at the end must also undergo collision before it can be discharged, which greatly increases the probability of foreign particles in the air being adsorbed.

Another object of the present invention is to provide more than one first spoiler on the inner wall of the electromagnetic field housing as needed to block and disturb the airflow to increase the stagnation time and collision frequency of air foreign particles and improve the dust collection effect. At the same time, the first baffle provided at the air duct outlet can be used to block the air foreign particles with only a few negative charges that are carried to the end by the airflow so that they collide with the inner wall of the electromagnetic field housing again and are completely adsorbed.

Still another object of the present invention is to provide a second baffle in the air duct body of the air duct outlet to block and intercept the foreign particles in the air again so that they will collide at a high speed and be adsorbed again. The extremely clean air will finally be discharged through the holes of the second baffle, thereby achieving effective adsorption and interception of foreign particles in the air and greatly improving the air purification effect.

### BRIEF DESCRIPTION OF THE DRAWINGS

FIG. 1 is a three-dimensional diagram of one of the preferred embodiments of the present invention.

FIG. 2 is a cross-sectional view of the present invention.

FIG. 3 is a diagram showing an embodiment of the present invention with two air duct inlets.

FIG. 4 is a diagram showing an embodiment of the present invention when at least one electromagnetic field housing is connected in series.

FIG. 5 is a three-dimensional diagram of another type of second spoiler installed in the electromagnetic field housing of the present invention.

FIG. 6 is a three-dimensional diagram of another type of second spoiler installed in the electromagnetic field housing of the present invention.

FIG. 7 is a three-dimensional diagram of an embodiment of the present invention when only one air inlet is provided.

FIG. 8 is a three-dimensional diagram of an embodiment of the present invention with two air inlets.

FIG. 9 is a longitudinal cross-sectional view of an embodiment of the present invention when a second baffle is provided in the air duct outlet.

FIG. 10 is a transverse cross-sectional view of an embodiment of the present invention when a second baffle is provided in an air duct outlet.

### DETAILED DESCRIPTION OF THE PREFERRED EMBODIMENT

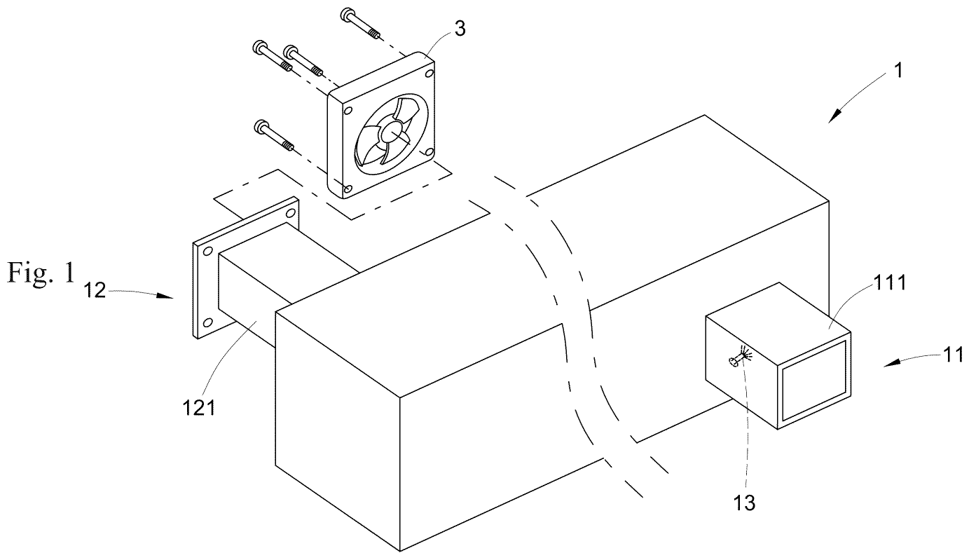

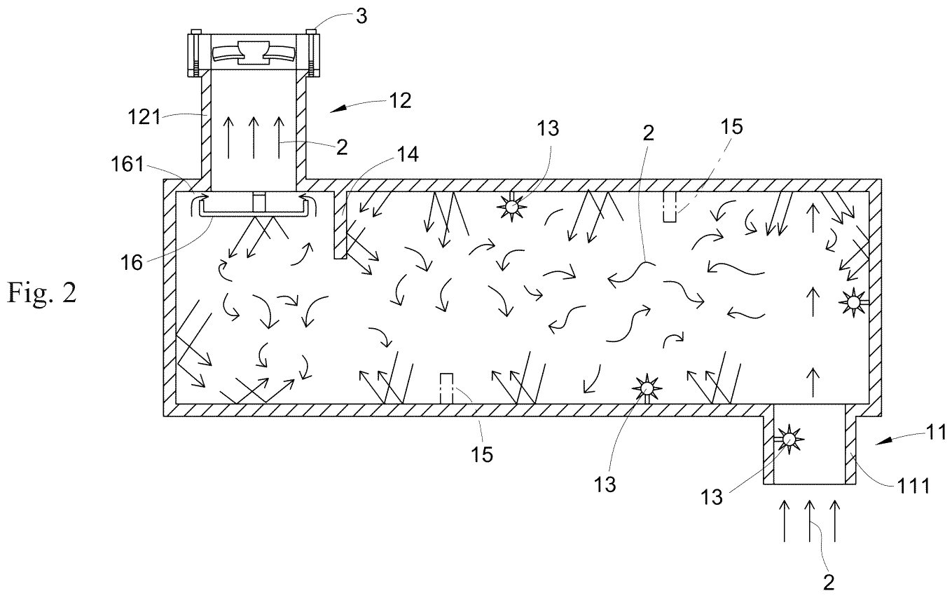

Please refer to FIG. 1 and FIG. 2. The present invention is related to an electromagnetic field air purifier, which comprises a positively charged electromagnetic field housing 1 with at least one air duct inlet 11 provided near one end thereof and at least one air duct outlet 12 provided on one side of an opposite end thereof. Negative ion generators 13 are provided in each air duct inlet 11 and inside the electromagnetic field housing 1. At least one first spoiler 15 is provided in the electromagnetic field housing 1. A barrier plate 14 is provided in the electromagnetic field housing 1 near one side of the air duct outlet 12 to prevent airflow from directly hitting the air duct outlet 12. A first baffle 16 may also be provided near the air duct outlet 12. A fan 3 is provided at an outer end of the air duct outlet 12. A gap 161 or hole is formed between the first baffle 16 and the air duct outlet 12, and the air 2 is sucked in by the fan 3 through the negative ion generator 13 to make the foreign particles in the air negatively charged. Negatively charged foreign particles in the air are driven by the airflow continuously inhaled by the fan 3 and enter the electromagnetic field housing 1 in a straight line. The negatively charged air particles in the continuously inhaled air flow will collide and rebound countless times with the inner wall of the electromagnetic field housing 1 at high speeds in the semi-enclosed space of the electromagnetic field housing 1 under Brownian motion, so that the negatively charged foreign particles in the air are attracted by the positively charged electromagnetic field housing 1 (opposite poles attract each other) in each super-high-speed collision, and the negatively charged foreign particles in the air are quickly adsorbed on the inner wall of the electromagnetic field housing 1. Furthermore, the one or more first spoilers 15 provided on the inner wall of the electromagnetic field housing 1 can block and disturb the airflow, thereby increasing the time that the negatively charged air foreign particles are stagnant in the electromagnetic field housing 1 and increasing the number of collisions, thereby improving the dust collection effect of the adsorbed particles. At the same time, the first baffle 16 installed near the air duct outlet 12 will block the negatively charged air foreign particles that are carried to the end by the airflow and make them collide with the inner wall of the electromagnetic field housing 1 again and be completely adsorbed again. The airflow flows out from the gap 161 between the first baffle 16 and the air duct outlet 12. Furthermore, the air duct inlet 11 and the air duct outlet 12 of the present invention are designed to be in a straight or non-straight path with the electromagnetic field housing 1, and the blocking and disturbance designs are added, so that the negatively charged air foreign particles are effectively blocked after entering and the probability of colliding with the inner wall of the electromagnetic field housing 1 is greatly increased, so that the air foreign particles are effectively adsorbed and intercepted, and the air purification effect is greatly improved.

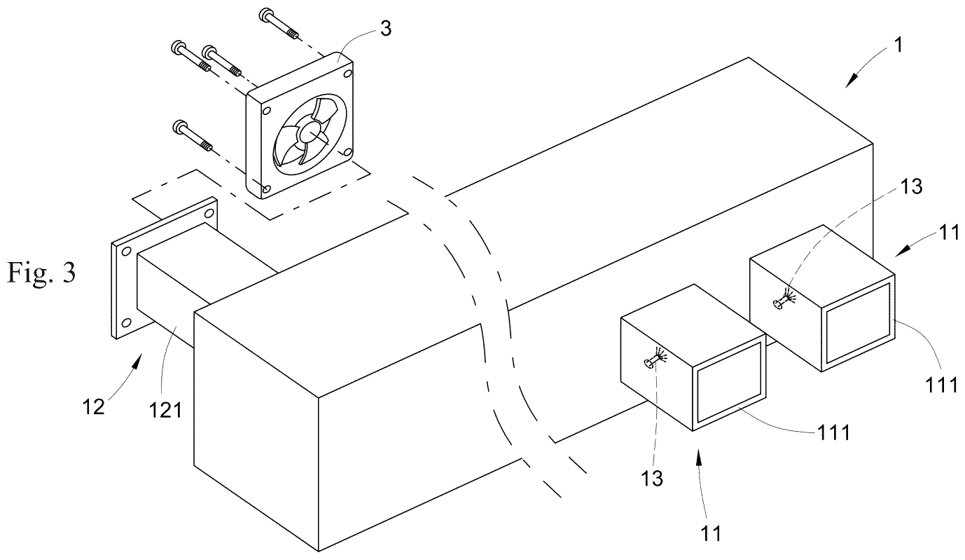

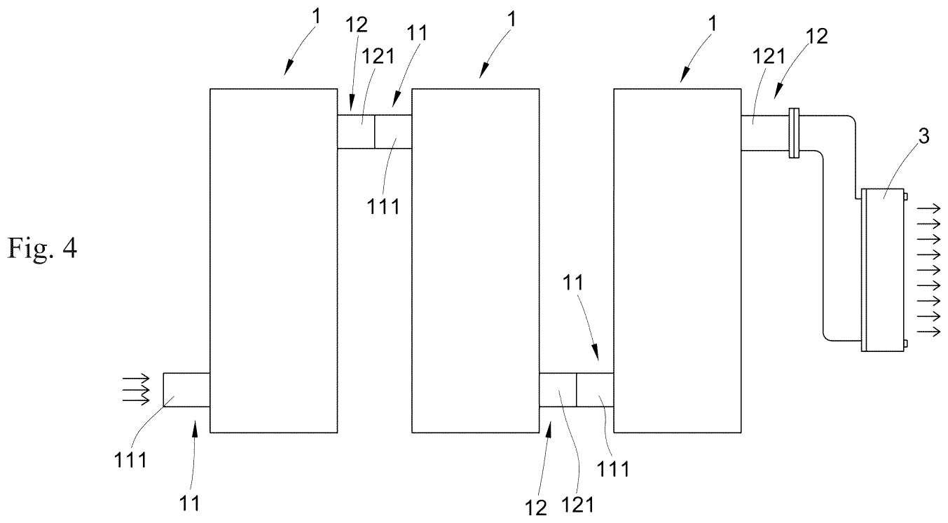

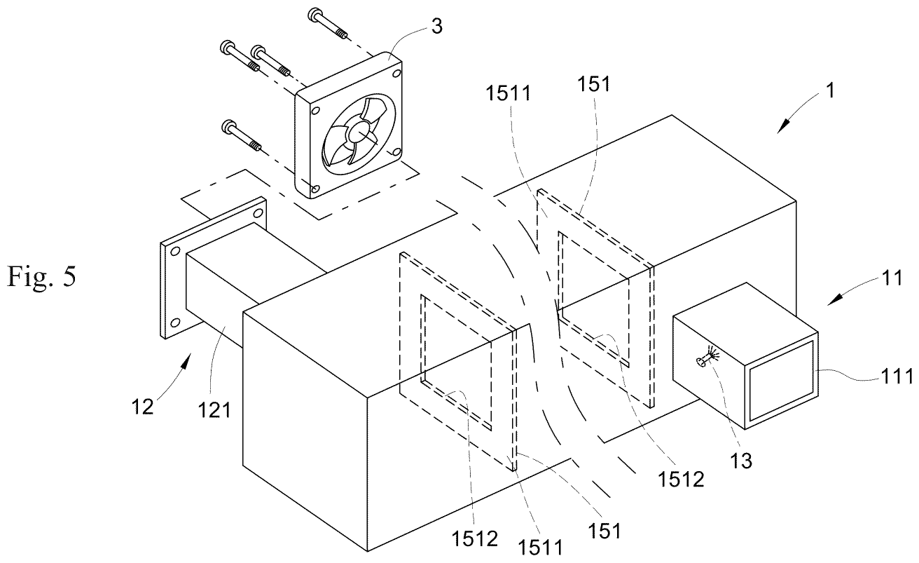

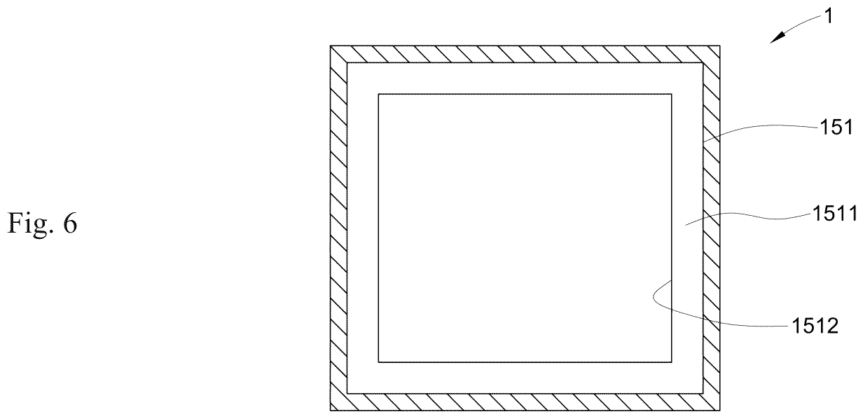

The air duct inlet 11 of the present invention can be at least one or more (as shown in FIG. 3), and through the design of the present invention, the air duct outlet 12 of more than one electromagnetic field housing 1 can be connected in series with the air duct inlet 11 of another electromagnetic field housing 1 to achieve multiple collision adsorption of air foreign particles and achieve an excellent air dust filtration effect (as shown in FIG. 4). In addition, in addition to the first spoiler 15 as shown in FIG. 1, the present invention can also provide at least one second spoiler 151 in the shape of “□”, i.e. having a rectangular shape (including by definition a square shape). The second spoiler 151 has spoiler portions 1511 all around, and only has a passage opening 1512 in the center for air flow to pass through (as shown in FIGS. 5 and 6). The second spoiler 151 also increases the disturbance, blocking and collision effects of the foreign particles in the air, and increases the frequency of collisions, thereby improving the air purification effect.

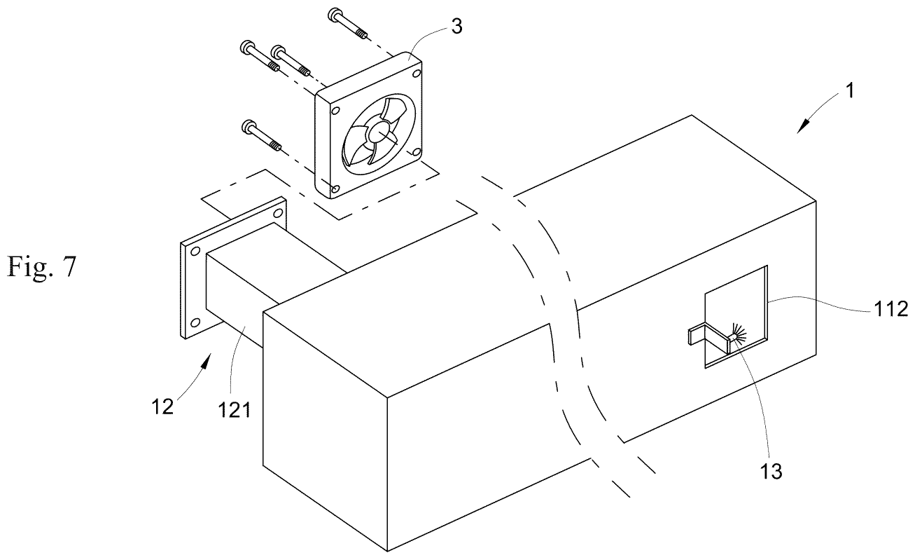

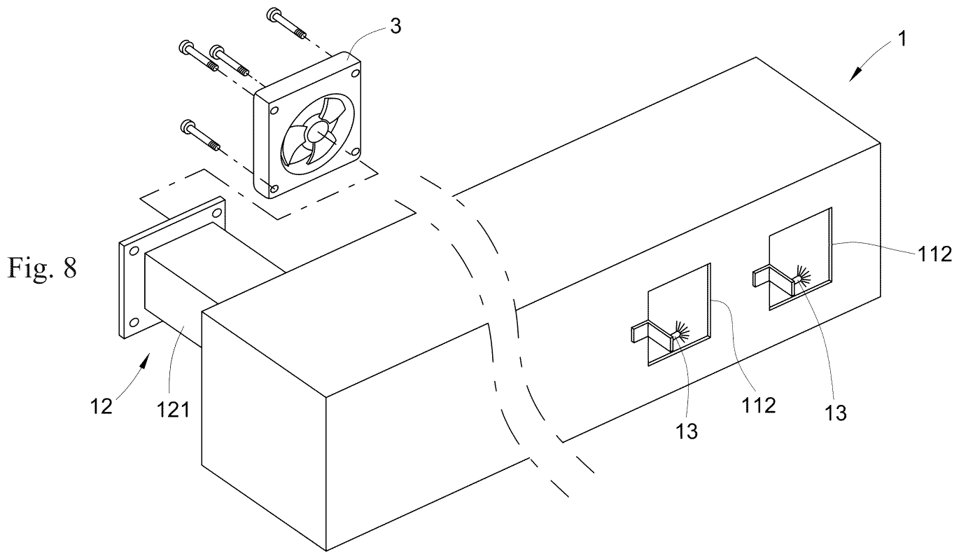

In addition to providing an air duct body 111 at the air duct inlet 11 and the air duct outlet 12 respectively (as shown in FIG. 1, FIG. 2 and FIG. 5), the present invention can also directly provide at least one air inlet 112 for the air 2 to enter the electromagnetic field housing 1 without providing the air duct body 111, and additional negative ion generator 13 is arranged at or in the air inlet 112 (as shown in FIG. 7 and FIG. 8).

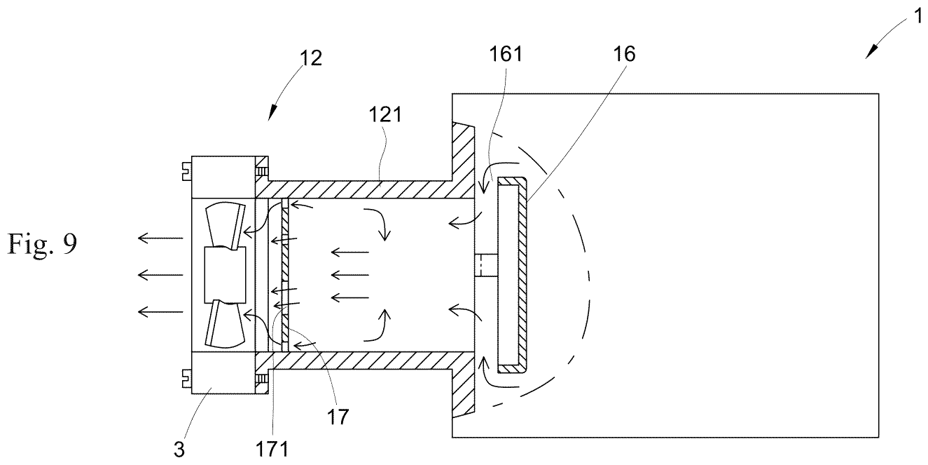

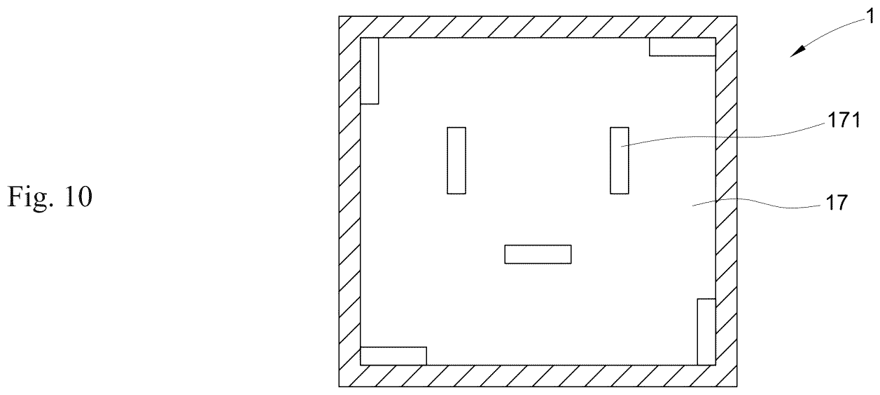

In addition, the present invention may further provide a second baffle 17 in the air duct body 121 of the air duct outlet 12, and at least one hole 171 is provided on the second baffle 17 for air to pass through. When the air flow is attracted by the continuous suction force of the fan 3 and enters the air duct body 121 of the air duct outlet 12 through the gap 161 around the first baffle 16, it will pass through the obstruction of the second baffle 17 so that only a very small amount of air foreign particles will produce ultra-high-speed collisions and be adsorbed by the inner wall of the air duct body 121 which is also positively charged. Finally, the clean air is discharged through the hole 171 of the second baffle 17 (as shown in FIGS. 9 and 10).

The first spoiler 15 and the second spoiler 151 mentioned above can be provided or not provided as required, and the first baffle 16 and the second baffle 17 can also be provided or not provided as required.

The electromagnetic field housing 1 can also be negatively charged, and a positive ion generator (not shown) is provided at the air duct inlet 11 to make the foreign particles in the air positively charged.

The invention can be used as the main component of an air filtration and purification device and can be designed to be easily disassembled and replaced. After being used for a period of time and the adsorbed air foreign particles are saturated, it can be disassembled and replaced. It has the characteristics of high efficiency, low energy consumption and sterilization, and can be widely used for dust purification in home rooms, public places, hospitals, factories and integrated circuit production and packaging plants.

In summary, the present invention can achieve an excellent air purification effect.

What is claimed is:

1. An electromagnetic field air purifier, comprising:
at least one positively charged electromagnetic field housing, each said positively charged electromagnetic field housing comprising at least one air duct inlet provided near one end thereof and at least one air duct outlet provided on one side of an opposite end thereof;
at least one first spoiler provided in each said positively charged electromagnetic field housing;
a first baffle set up at each said air duct outlet of each said positively charged electromagnetic field housing with a gap formed between the respective said first baffle and the respective said air duct outlet;
a barrier plate installed on one side of the said at least one air duct outlet of each said positively charged electromagnetic field housing to prevent the airflow from directly hitting the said air duct outlet;
a plurality of negative ion generators provided in each said air duct inlet and inside said positively charged electromagnetic field housing; and
a fan installed at an outer side of each said air duct outlet of each said positively charged electromagnetic field housing;
wherein each said fan sucks in air to flow through the respective said negative ion generators to make foreign particles in the air negatively charged, and the said negatively charged foreign particles in the air are driven by the airflow continuously inhaled by each said fan and enter each said positively charged electromagnetic field housing in a straight line, and the said negatively charged air particles in the continuously inhaled air flow collide and rebound countless times with an inner wall of each said positively charged electromagnetic field housing at high speeds in the semi-enclosed space of each said positively charged electromagnetic field housing under Brownian motion, so that the said negatively charged foreign particles in the air are attracted by each said positively charged electromagnetic field housing in each super-high-speed collision, and the said negatively charged foreign particles in the air are quickly adsorbed on the said inner wall of each said positively charged electromagnetic field housing, and each said first spoiler provided on the said inner wall of each said positively charged electromagnetic field housing blocks and disturbs the airflow, thereby increasing the time that the said negatively charged air foreign particles are stagnant in each said positively charged electromagnetic field housing and increasing the number of collisions, thereby improving the dust collection effect of the adsorbed particles, and at the same time, each said first baffle installed at the respective said air duct outlet carry the airflow to the end, and the negatively charged air foreign particles are blocked again, causing the negatively charged air foreign particles to collide with the said inner wall of each said positively charged electromagnetic field housing and be completely adsorbed again, and finally, the airflow flows out from the said gap between each said first baffle and the respective said air duct outlet.

2. The electromagnetic field air purifier as claimed in claim 1, which comprises a plurality of positively charged electromagnetic field housings connected in series by connecting the said air duct outlet of one said positively charged electromagnetic field housing to the said air duct inlet of another said positively charged electromagnetic field housing.

3. The electromagnetic field air purifier as claimed in claim 1, further comprising at least one second spoiler having a rectangular shape provided in each said positively charged electromagnetic field housing, each said second spoiler comprising a plurality of spoiler portions all around, and a passage opening in the center for air flow to pass through, said at least one second spoiler being used to increase the disturbance, blocking and collision of foreign particles in the air, and increase the frequency of collisions, thereby improving the air purification effect.

4. The electromagnetic field air purifier as claimed in claim 1, further comprising a plurality of air duct bodies respectively provided at each said air duct inlet and said air duck outlet of each said positively charged electromagnetic field housing, said air duct body located at each said air duct inlet having at least one said negative ion generator provided therein.

5. The electromagnetic field air purifier as claimed in claim 1, wherein each said positively charged electromagnetic field housing is provided with at least one air inlet, each said air inlet having at least one said negative ion generator provided therein.

6. The electromagnetic field air purifier as claimed in claim 4, further comprising a second baffle located in said air duct body at each said air duct outlet of each said positively charged electromagnetic field housing, said second baffle being provided with at least one hole for air to pass through, such that when the air flow is attracted by the continuous suction force of each said fan and enters the said air duct body at each said air duct outlet of each said positively charged electromagnetic field housing through the said gap around the respective said first baffle, the air flow then passes through the obstruction of the said second baffle so that only a small amount of air foreign particles produce ultra-high-speed collisions and be adsorbed by the said inner wall of the said air duct body which is also positively charged, and finally, the clean air is discharged through the said at least one hole of the said second baffle.

7. The electromagnetic field air purifier as claimed in claim 1, wherein at least one negatively charged electromagnetic field housing is used to replace said at least one positively charged electromagnetic field housing, and a plurality of positive ion generators are used to replace said negative ion generators.

8. An electromagnetic field air purifier, comprising:
at least one positively charged electromagnetic field housing, each said positively charged electromagnetic field housing comprising at least one air duct inlet provided near one end thereof and at least one air duct outlet provided on one side of an opposite end thereof;
at least one first spoiler provided in each said positively charged electromagnetic field housing;
a barrier plate installed on one side of the said at least one air duct outlet of each said positively charged electromagnetic field housing to prevent the airflow from directly hitting the said air duct outlet;
a plurality of negative ion generators provided in each said air duct inlet and inside said positively charged electromagnetic field housing; and
a fan installed at an outer side of each said air duct outlet of each said positively charged electromagnetic field housing;
wherein each said fan sucks in air to flow through the respective said negative ion generators to make foreign particles in the air negatively charged, and the said negatively charged foreign particles in the air are driven by the airflow continuously inhaled by each said fan and enter each said positively charged electromagnetic field housing in a straight line, and the said negatively charged air particles in the continuously inhaled air flow collide and rebound countless times with an inner wall of each said positively charged electromagnetic field housing at high speeds in the semi-enclosed space of each said positively charged electromagnetic field housing under Brownian motion, so that the said negatively charged foreign particles in the air are attracted by each said positively charged electromagnetic field housing in each super-high-speed collision, and the said negatively charged foreign particles in the air are quickly adsorbed on the said inner wall of each said positively charged electromagnetic field housing, thereby improving the dust collection effect of the adsorbed particles, and finally, the airflow flows out from the respective said air duct outlet.

9. An electromagnetic field air purifier, comprising:
at least one positively charged electromagnetic field housing, each said positively charged electromagnetic field housing comprising at least one air duct inlet provided near one end thereof and at least one air duct outlet provided on one side of an opposite end thereof;
at least one first spoiler provided in each said positively charged electromagnetic field housing;
a barrier plate installed on one side of the said at least one air duct outlet of each said positively charged electromagnetic field housing to prevent the airflow from directly hitting the said air duct outlet;
a plurality of negative ion generators provided in each said air duct inlet and inside said positively charged electromagnetic field housing; and
a fan installed at an outer side of each said air duct outlet of each said positively charged electromagnetic field housing;
wherein each said fan sucks in air to flow through the respective said negative ion generators to make foreign particles in the air negatively charged, and the said negatively charged foreign particles in the air are driven by the airflow continuously inhaled by each said fan and enter each said positively charged electromagnetic field housing in a straight line, and the said negatively charged air particles in the continuously inhaled air flow collide and rebound countless times with an inner wall of each said positively charged electromagnetic field housing at high speeds in the semi-enclosed space of each said positively charged electromagnetic field housing under Brownian motion, so that the said negatively charged foreign particles in the air are attracted by each said positively charged electromagnetic field housing in each super-high-speed collision, and the said negatively charged foreign particles in the air are quickly adsorbed on the said inner wall of each said positively charged electromagnetic field housing, and each said first spoiler provided on the said inner wall of each said positively charged electromagnetic field housing blocks and disturbs the airflow, thereby increasing the time that the said negatively charged air foreign particles are stagnant in each said positively charged electromagnetic field housing and increasing the number of collisions, thereby improving the dust collection effect of the adsorbed particles, and finally, the airflow flows out from the said gap between each said first baffle and the respective said air duct outlet.
